(19) United States
(12) Patent Application Publication
(10) Pub. No.: US 2013/0206098 A1
(43) Pub. Date: Aug. 15, 2013

(54) Engine Maintenance Apparatus and Method

(71) Applicant: Ronald Dene BETTS, SR., Pottsboro, TX (US)

(72) Inventor: Ronald Dene BETTS, SR., Pottsboro, TX (US)

(21) Appl. No.: 13/767,597

(22) Filed: Feb. 14, 2013

Related U.S. Application Data
(60) Provisional application No. 61/599,141, filed on Feb. 15, 2012.

(51) Int. Cl. F02B 77/00

(52) U.S. Cl. CPC F02B 77/00
USPC 123/198 R; 29/888

(57) ABSTRACT

An apparatus for maintaining engines including a support cradle and neck support for bearing the load of multiple exhaust system components simultaneously during removal, maintenance, and/or reattachment to the engine. The neck support includes one or more separators and cutouts to support exhaust manifold necks and limit lateral movement of the exhaust manifolds during removal and maintenance. The apparatus includes structural supports designed for allowing maneuverability into an engine for proper placement. A method of using the apparatus for removal, maintenance, and/or reattachment of exhaust manifolds to an engine.

### CROSS-REFERENCE TO RELATED APPLICATION

This application claims the benefit of priority from U.S. Provisional Application No. 61/599,141 filed on Feb. 15, 2012.

### FIELD OF THE DISCLOSURE

The invention relates to the maintenance of engines. More specifically, the invention relates to methods and apparatus for maintaining engines.

### BACKGROUND

During operation, engines often create high temperatures, vibrations, and other stress causing wear and tear on the engine components. In order to properly care for an engine, prevent failures, and extend its operational life, maintenance is often conducted on engines. Engine maintenance may include routine maintenance, such as checking and filling fluids and changing oil, and/or more in depth maintenance, such as cleaning or refurbishing parts or replacement of gaskets. Engine maintenance may also include the repair or replacement of broken parts.

Engine maintenance for large engines, such as those used in power generation at industrial location, may entail removal of numerous parts which may be heavy and susceptible to damage during removal. One example of a large engine is the CAT G3520C Gas Engine made by Caterpillar and depicted in FIG. 1. An image of the CAT G3520C Gas Engine may be found on CAT's website at http://www.cat.com/cda/files/220277/7/LEHE0009-03.pdf.

Large engines often include exhaust systems to direct heated air away from the rest of the engine. Components in the exhaust systems are often made of materials that can withstand high heats, such as cast iron and ceramics. Some of these materials such as the ceramics may not be suited to certain physical stresses that may occur during their removal as part of engine maintenance. For example, removal of exhaust manifolds and couplings may cause damage to either or both components due to the weight and structural stresses applied to the components. One common form of harm is damage to the coupling, such as cracking, caused by the heavy exhaust manifold turning out of alignment with the coupling and causing a torque based structural stress which the coupling is not designed to withstand. In some cases, the parts that are susceptible to damage may be very expensive to replace.

Accordingly, engine maintenance on the exhaust manifolds of large engines often requires a tedious and time-consuming effort to minimize damage. For example, engines like the CAT G3520C Gas Engine shown in FIG. 1 may contain ten cast iron exhaust manifolds with ceramic couplings between each manifold. Often the safest way to remove the exhaust manifolds is individually due to their weight. However, if the removal of the exhaust manifolds is not precise, they will cause stress on the ceramic coupling which may lead to cracks. This tedious and time-consuming process lowers the benefits of power generation because the generator must be shut-off throughout the process of removing the exhaust manifolds, maintaining the manifold pieces, replacing gaskets, and reattaching the maintained exhaust manifolds. In addition, the maintenance of the exhaust system raises expenses because it requires workers to be present during the removal and reattachment of the exhaust manifold, who may not regularly be present at the site of the power generator.

### SUMMARY

The present disclosure describes an apparatus and a method of using the apparatus to safely remove and reattach multiple exhaust manifolds of an engine without damaging the parts of the exhaust system.

The apparatus comprises a jig designed to hold one or more exhaust manifolds in a stable position during removal and reattachment of the manifolds for engine maintenance. In some embodiments, jigs may be designed to match the specific engines. In some embodiments, separate jigs may be used for various groupings of exhaust manifolds on one engine. The jigs may be designed with specific tolerances such that they do not damage other parts of the engine, such as adjacent or nearby piping, during placement and removal of the jigs.

An embodiment of the apparatus may be used by moving the jig into position under the exhaust manifold system while that system remains attached to the engine. The jig may be placed such that the jig cradles one or more exhaust manifolds while additionally supporting the necks of the exhaust manifolds. The neck of the exhaust manifolds may fit in a cutout between raised portions of the jig to minimize lateral movement of the exhaust manifolds. Once the jig is properly aligned and the weight of the exhaust manifolds is distributed along the jig, all the supported exhaust manifolds may be detached from the engine and other unsupported components. When all connections to the engine are removed, the exhaust manifolds may be removed simultaneously in a steady alignment preventing unwanted stresses to the exhaust system components. When maintenance or repairs on the engine and/or components thereof are completed, the jig may be used to reattach the exhaust manifold components.

Additional aspects, advantages and features of the present invention are included in the following description of exemplary examples thereof, which description should be taken in conjunction with the accompanying figures, wherein like numerals are used to describe the same feature throughout the figures.

### A BRIEF DESCRIPTION OF THE DRAWINGS

FIG. 1 is an image of a CAT G3520C Gas Engine;

FIG. 2A is a front view drawing of an embodiment of the apparatus disclosed herein;

FIG. 2B is a side view drawing of an embodiment of the apparatus disclosed herein;

FIG. 2C is a perspective view drawing the front of an embodiment of the apparatus disclosed herein;

FIG. 3A is a front view drawing of a second embodiment of the apparatus disclosed herein;

FIG. 3B is a side view drawing of a second embodiment of the apparatus disclosed herein;

FIG. 3C is a perspective view drawing the front of a second embodiment of the apparatus disclosed herein;

FIG. 3D is a top view drawing of a second embodiment of the apparatus disclosed herein;

FIG. 4 is a drawing of a segment of an exhaust manifold system;

FIG. 5 is a cross-section view of an exhaust manifold with insulation and a heat shield; and

FIG. 6 is a cross-section view an exhaust manifold supported by an embodiment of the apparatus disclosed herein.

### DETAILED DESCRIPTION

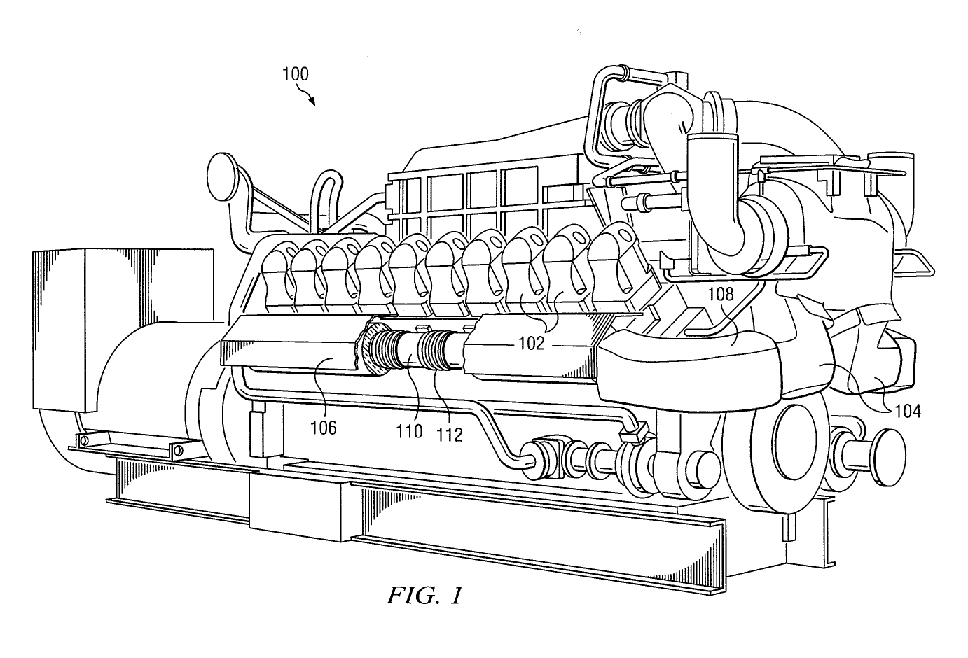

FIG. 1 shows a depiction of a CAT G3520C Gas Engine (“engine 100”) with a cutaway section. An image of the CAT G3520C Gas Engine may be found on CAT's website at http://www.cat.com/cda/files/220277/7/LEHE0009-03.pdf. This engine is referred to herein for purposes of illustration. One skilled in the art will recognize that the devices and methods disclosed herein may be applicable to other engines as well. The engine 100 includes twenty headers 102 with ten on each side of the engine 100. Exhaust system 104 provides a system and pathway for the hot engine exhaust to exit the engine 100 and be directed elsewhere, such as the ambient, a filter system, or a temperature dissipation system. The exhaust system 104 includes twenty exhaust manifolds 110, wherein each of the exhaust manifolds 110 is separately associated with each of the headers 102. The exhaust manifolds are covered during operation of the engine 100 by heat shield 106 and insulation 108. In between exhaust manifolds 110 are connectors 112.

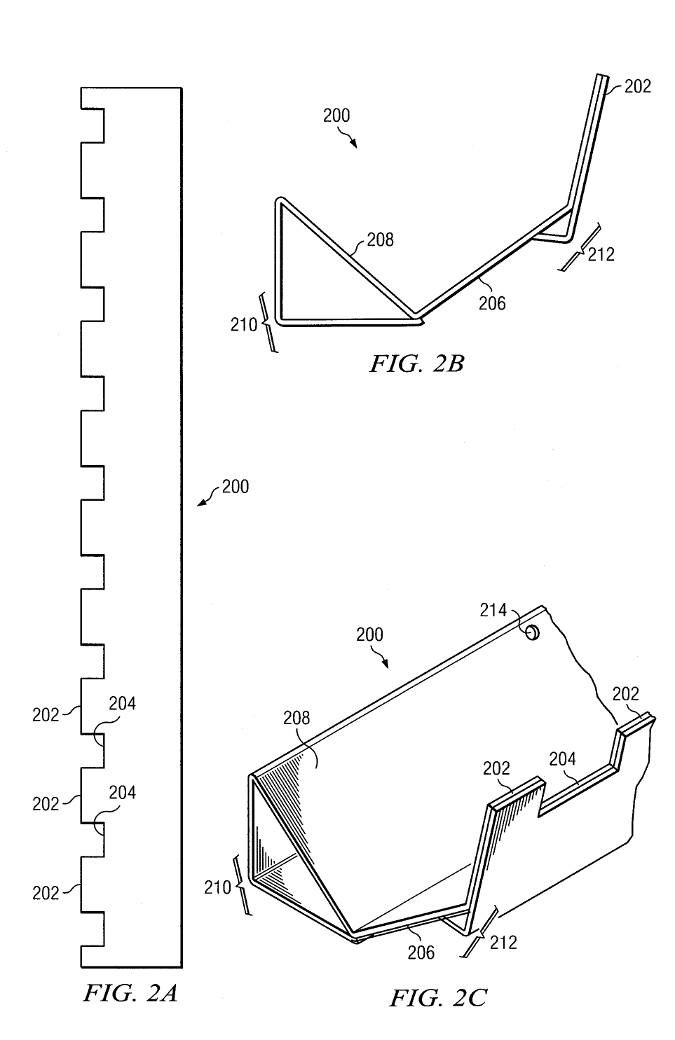

FIGS. 2A, 2B, and 2C depict an embodiment of the apparatus of the present disclosure. Jig 200 is shown from a front view (FIG. 2A), a side view (FIG. 2B), and a perspective view (FIG. 2C). The front view of jig 200 depicts an exhaust manifold neck support section with a pattern of separators 202 and cutouts 204. The number and dimensions of the separators 202 and the cutouts 204 are dependent upon the design and dimensions of the engine on which it is to be used and specifically, the placement of the engine's exhaust manifolds. For example, the separators 202 may be 6 inches long with 4 inch long cutouts 204 between the separators 202. In some embodiments, the dimensions of the separators 202 and the cutouts 204 may differ between jigs used on separate sections of the engine. Accordingly, dimensions may vary and remain within the scope and spirit of the present disclosure. In the embodiment shown, the pattern of the separators 202 to the cutouts 204 is relatively consistent, but may be varied along the jig 200 consistent with the design of the corresponding engine.

During operation of the jig 200 to remove or reattach exhaust manifolds, the jig 200 is so positioned relative to the engine that the necks of exhaust manifolds are fitted in the cutouts 204 between the separators 202, whereby the separators 202 limit lateral movement of the exhaust manifolds and minimize the potential for damage caused by lateral movement of the exhaust manifolds. One skilled in the art will recognize that the jig 200 may be designed as a semi-flat support without the pattern of the separators 202 and the cutouts 204 and remain within the scope and spirit of this disclosure. In addition, the neck support may comprise other designs than the separators 202 and the cutouts 204 illustrated, such as waves and angled edges that assist in limiting lateral movement of the exhaust manifolds held in jig 200.

FIG. 2B shows a side view of the jig 200. The edge of the neck support with the separator 202 extended is shown. Attached to the neck support is front plate 206 which leads to back plate 208 opposite from the neck support. The front plate 206 and the back plate 208 form an angular cradle to support one or more exhaust manifolds during operation. In this embodiment, structural support for the jig 200 is provided by the back support 210 and the front support 212. Back support 210 provides a triangular support from the cradle of the jig 200 to the top of the back plate 208. Front support 212 is shown as a triangular support to the connection between the neck support and the front plate 206. In this embodiment, the front support 212 only extends partially down front plate 206 in order to allow more room for maneuvering the jig 200 into place without damaging other engine components, such as the piping shown under the exhaust system 104 in FIG. 1.

One skilled in the art will recognize that structural supports may not be necessary for some embodiments of the jig 200. For example, dependent on the weight of the exhaust manifolds and engine components to be removed and reattached by the jig 200, some embodiments may be made from materials with sufficient structural integrity to operate safely without using structural supports. In some embodiments, the jig 200 may be made using a variety of materials for specific components. In some embodiments, alternative structural support may be used to ensure the structural integrity of the jig 200 during use. One skilled in the art will recognize that the design of the jig 200 and selection of materials may be altered while maintaining a sufficient rigidity to support the weight of the exhaust manifolds and other engine components which may be removed and/or reattached using the jig 200.

FIG. 2C shows a perspective view of the jig 200. As discussed above, the neck support comprises the separators 202 and the cutouts 204, and is connected to the front plate 206. The front plate 206 and the back plate 208 create a cradle to support exhaust manifolds. In this embodiment, the jig 200 includes the back support 210 and the front support 212, in order to provide additional structural support to the jig 200. In addition, this perspective view shows hole 214 which may be used to connect a load bearing apparatus. For example, a bolt with an eye at the top may be placed through the hole 214. The eye of the bolt may be connected to a chain and attached to a lifting system in order to bear the weight of the jig 200 and all exhaust manifolds and engine components which may be held on the jig 200. Opposite of the hole 214 a second hole (not shown) may also include an eye bolt that may be attached to a chain and a lifting system. In addition, another pair of holes and eye bolts may be at the opposite end of the jig 200. The threaded eye bolts may be used to provide adjustment to the jig 200 when placing the jig 200 under the exhaust manifolds.

One skilled in the art will recognize that the jig 200 may be designed and manufactured in any number of methods, including methods yet to be discovered. For example, the jig 200 may be molded from a single sheet of metal or other material, comprised of multiple sheets of cut material which are then after attached to each other, cut from a single block of material, or other form of manufacture. If multiple pieces are attached to each other, they may be attached through any means known or yet to be discovered, including welding, adhering, bolting, riveting, or other means of attachment.

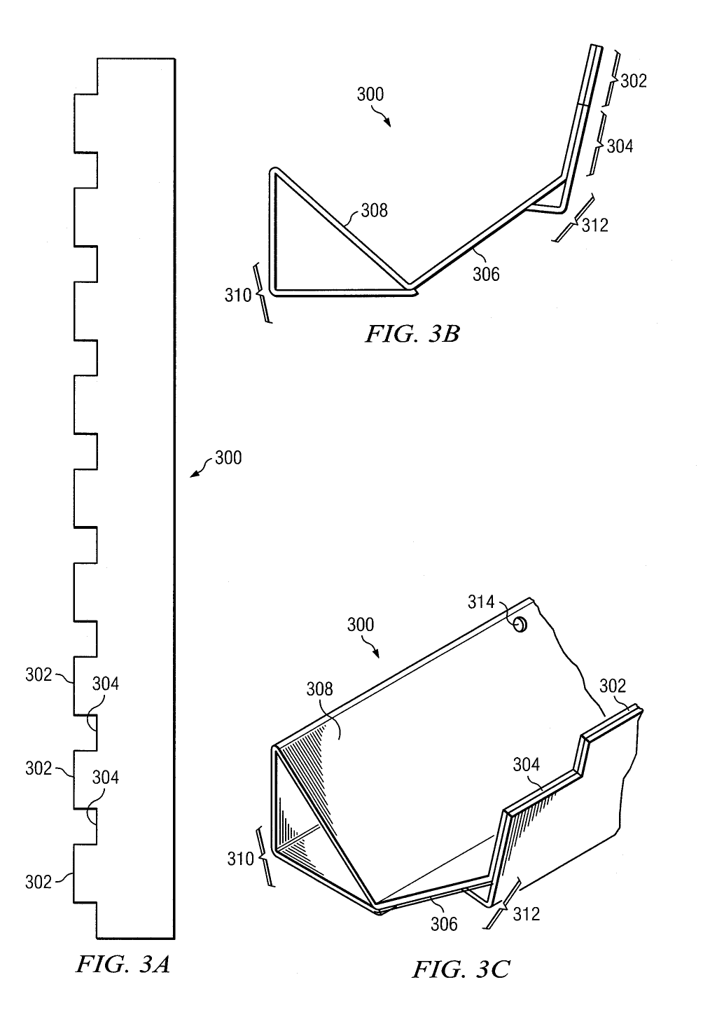

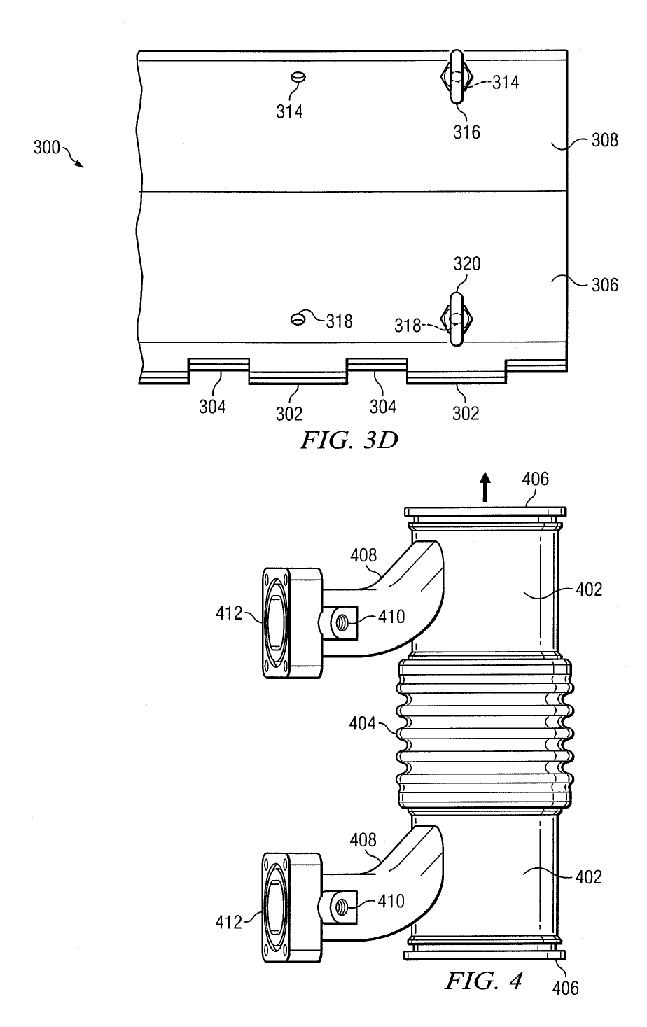

FIGS. 3A, 3B, 3C, and 3D depict an embodiment of the apparatus of the present disclosure. Jig 300 is shown from a front view (FIG. 3A), a side view (FIG. 3B), a perspective view (FIG. 3C), and a top view (FIG. 3D). The embodiment shown in these figures is similar to the embodiment from the FIGS. 2A, 2B, and 2C, except that the ends of the neck support have cutouts 304 as opposed to the separator 202 in FIGS. 2A, 2B, and 2C. One skilled in the art will recognize that the ends of the jigs may vary between using a cutout or a separator, and the some jigs may have a cutout at one end and a separator at the other end. Further, the dimensions of the cutout or separator located at the ends may vary. The design of the jigs and the ends is dependent upon the design and tolerances of the relevant engine.

In FIG. 3A, the front view of the jig 300 depicts an exhaust manifold neck support section with a pattern of separators 302 and cutouts 304. The number and dimensions of the separators 302 and the cutouts 304 are dependent upon the design of the associated engine and specifically, the placement of exhaust manifolds. As discussed with regard to FIGS. 2A, 2B, and 2C, the design of the neck support and of the separators 302 and the cutouts 304 may vary and remain within the scope and spirit of the present disclosure. Similar to the operation described above for removal or reattaching exhaust manifolds, the necks of exhaust manifolds may be fitted in the cutouts 304 between the separators 302, whereby the separators 302 limit lateral movement of the exhaust manifolds and minimize the potential for damage caused by lateral movement of the exhaust manifolds.

FIG. 3B shows a side view of the jig 300. The edge of the neck support with the cutout 304 is shown, with the first separator 302 from the edge shown in a dashed line. Attached to the neck support is front plate 306 which leads to back plate 308 opposite from the neck support. Similar to above, the front plate 306 and the back plate 308 form an angular cradle to support one or more exhaust manifolds during operation. In this embodiment, structural support for the jig 300 is provided with back support 310 and front support 312. The back support 310 provides a triangular support from the cradle of the jig 300 to the top of the back plate 308. The front support 312 is shown as a triangular support to the connection between the neck support and the front plate 306. In this embodiment, the front support 312 only extends partially down the front plate 306 in order to allow more room for maneuvering the jig 300 into place without damaging other engine components, such as the piping shown under the exhaust system 104 in FIG. 1. As discussed above, one skilled in the art will recognize that structural supports may be altered, or may not be necessary for some embodiments of the jig 300.

FIG. 3C shows a perspective view of the jig 300. As discussed above, the neck support comprises the separators 302 and the cutouts 304, and is connected to the front plate 306 which forms a cradle with the back plate 308 to support exhaust manifolds. In this embodiment, the jig 300 includes the back support 310 and the front support 312, in order to provide additional structural support to the jig 300. In addition, this perspective view shows hole 314 which may be used to connect a load bearing apparatus.

FIG. 3D shows a generally top view of the jig 300. This view better illustrates the load bearing connections. The holes 314 are shown in the back plate 308 with corresponding holes 318 found in the front plate 306. In this embodiment, eye bolts 316 and 320 are illustrated through one pair of corresponding holes 314 and 318. In addition, another pair of the holes 314 and 318 and the eye bolts 316 and 320 may be at the opposite end of the jig 300. One skilled in the art will recognize that additional holes 314 and 316 may allow for selecting the preferred location for the eye bolts 316 and 320 or the utilization of additional eye bolts, but may not be included in some embodiments of the jig 300. The eye bolts 316 and 320 may be connected to a chain and attached to a lifting system in order to bear the weight of the jig 300 and all exhaust manifolds and engine components which may be held on the jig 300. One skilled in the art will recognize that other components may be used to attach the jig 300 to a lifting system to bear the load on the jig 300. The eye bolts 316 and 320 may be used to provide adjustment to the jig 300 when placing the jig 300 under the exhaust manifolds. For example, the eye bolts 316 and 320 may be threaded and include a set of nuts and washers to provide small adjustments for proper placement of the jig 300.

FIG. 4 depicts a segment of an exhaust manifold system for illustration. Two exhaust manifolds 402 connected by coupling 404 make up the segment shown. An exhaust manifold system may include one or more additional exhaust manifolds 402 and couplings 404. For example, the engine 100 shown in FIG. 1 has ten exhaust manifolds 402 with couplings 404 connecting them on each side. In some embodiments, the exhaust manifolds 402 may be made of a material, such as cast iron, while the couplings are made of an alternate material, such as a ceramic material. In this embodiment, coupling 404 is shown with a corrugated exterior. It will be appreciated that the design of coupling 404 and/or any exhaust manifold connector may vary.

The exhaust manifolds 402 include necks 408 that end with engine connections 412. The engine connections 412 attach to the exhaust output from engine headers, such as the headers 102 from FIG. 1, and direct the exhaust created during the combustion process in the engine through the exhaust manifold necks 408 into the exhaust system. In an exhaust system, multiple exhaust manifolds 402 are used to direct the hot exhaust in one direction away from the engine.

In some embodiments, sensor connections 410 are located in the exhaust manifold necks 408, and provide access to the inside of the exhaust manifold necks 408. The sensor connections 410 may be capped, or sensors may be attached to the sensor connections 410. For example, in some embodiments, temperature sensors are attached to the sensor connections 410 such that the temperature of the exhaust air or the exhaust system may be observed.

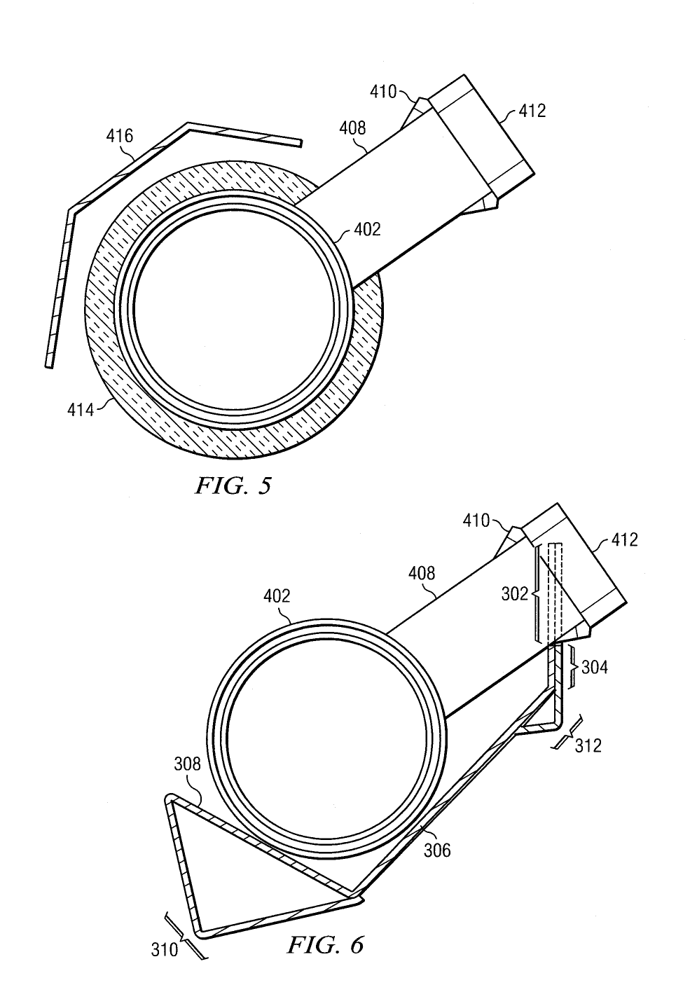

FIG. 5 depicts a cross-section view of the exhaust manifold 402 with insulation 414 and heat shield 416 around the exterior of the exhaust manifold 402. In some embodiments of exhaust systems, the exhaust manifolds 402 and the couplings 404 may be insulated to limit the dissipation of heat from the exhaust near the engine. Accordingly, a layer of the insulation 414 may surround all or part of the exhaust manifold, and the heat shield 416 may further surround part of the exhaust manifold system during engine operation. During engine maintenance, the heat shield 416 and the insulation 414 may be removed prior to removal of the exhaust manifolds 402.

FIG. 6 depicts a cross-section view of the exhaust manifold 402 as supported by the jig 300 during at least one of removal, maintenance, and reattachment of the exhaust manifold system. As discussed elsewhere herein, the jig 300 cradles the exhaust manifold 402 between the front plate 306 and the back plate 308 and supports the exhaust manifold neck 408 on the neck support in the cutout 304. The separator 302, illustrated by the dotted line, remains adjacent to the exhaust manifold neck 408 and limits lateral movement of the exhaust manifold 402.

The jig 300 may be used to remove the exhaust manifolds 402 and the couplings 404 from an engine. In order to remove the exhaust manifolds 402 and the couplings 404, the engine may be shut off and the heat shield 416 and the insulation 414 removed once the engine components reach a safe and workable temperature. With the heat shield 416 and the insulation 414 out of the way, users may attach the jig 300 to a lifting mechanism using the eye bolts 316 and 320 to hold the weight of the jig 300. The jig 300 may then be maneuvered next to the exhaust manifolds 402 of the engine and adjusted to the correct height based upon the engine.

Next, the neck support section of the jig 300 may be tilted downward (and/or the back of the jig 300 lifted upward) such that the leading edge of the jig 300 may move under the exhaust manifolds 402 and the couplings 404. As the neck support moves underneath the exhaust manifolds 402, the jig 300 may be tilted in an opposite direction from before—raising the neck support and/or lowering the back of the jig 300. During this process, the jig 300 should be placed such that the separators 302 pass between and/or next to the exhaust manifold necks 408, and the cutouts 304 either engage the exhaust manifold necks 408 or are located within a tolerance of the exhaust manifold necks 408 such that a slight lift of the exhaust manifolds 402 will allow engagement with the exhaust manifold necks 408. In addition, the front plate 306 and the back plate 308 should cradle the exhaust manifolds 402. In some embodiments, the alignment and engagement between the exhaust manifolds 402 and the jig 300 may be adjusted by altering the height of the eye bolts 316 and 320.

When the jig 300 is properly placed, it may be slightly lifted to bear the weight of the exhaust manifolds 402. When slightly lifted, connections between the exhaust manifolds 402 and the engine may be removed. For example, bolts holding the exhaust manifolds 402 to engine headers may be removed and any attached sensors may be removed. Once all connections to other engine components are removed from the exhaust manifolds 402 and the couplings 404, the jig 300 may be lifted and maneuvered away from the engine carrying the exhaust manifolds 402 and the couplings 404.

Once maintenance is completed, the jig 300 may be used to move the exhaust manifolds 402 and the couplings 404 back into place with the engine. While the jig 300 continues to support the exhaust manifolds 402 and the couplings 404, they may be reattached to the engine. Once the exhaust manifolds 402 are reattached, the jig 300 may be lowered and tilted to pull the jig 300 out from under the exhaust manifolds 402 and the couplings 404.

In addition to facilitating simultaneous removal of multiple exhaust manifolds 402 and couplings 404, the jig 300 provides the ability to maintain alignment during the process and allow lateral separation of the exhaust manifold from the coupling while they are supported, thereby minimizing the likelihood of damage to the components.

One skilled in the art will recognize that some steps may be rearranged, altered, added and/or left off from the above description and remain within the scope and spirit of the disclosure. Some alterations in the process may be due to the design of the engine. For example, users may have to place the jig 300 in proper alignment prior to attaching the lift mechanism to the jig 300, due to the placement of engine components.

It will be obvious that the disclosure herein and elements thereof may be varied in many ways. Such variations are not to be regarded as a departure from the spirit and scope of the disclosure and all such modifications as would be obvious to one skilled in the art are intended to be included within the scope of the apparatus and method described.

What is claimed:

1. An engine maintenance apparatus comprising:
a front side, wherein said front side includes at least one cutout adjacent to at least one separator, wherein said cutout and said separator are dimensioned such that a first portion of an engine component fits in said cutout adjacent to said separator during operation of said apparatus;
a back side connected to said front side such that a cradle is created between said back side and said front side, wherein during operation of said apparatus a second portion of said engine component is supported in said cradle;
a first end having at least one first lift attachment device;
a second end having at least one second lift attachment device, wherein during operation of said apparatus said first lift attachment device and said second lift attachment device are adjustable to orient said apparatus with said engine component; and
wherein said apparatus is sufficiently rigid to support said engine component.

2. The apparatus according to claim 1 comprising at least one support which provides additional structural support along the length of said apparatus.

3. The apparatus according to claim 2 wherein said at least one support comprises a front support which supports an angular transition adjacent to said front side of said apparatus, wherein said front support is dimensioned such that during operation of said apparatus said front side and said front support may pass between parts of said engine.

4. The apparatus according to claim 1 comprising a plurality of said cutouts and a plurality of said separators, wherein said apparatus supports a plurality of said engine components during operation of the apparatus.

5. The apparatus according to claim 4 wherein said plurality of said engine components comprise a plurality of engine exhaust manifolds each having a neck portion and a body portion, wherein during operation of said apparatus said body portions are supported by said cradle and said neck portions are supported in said cutouts and are adjacent to at least one of said separators.

6. The apparatus according to claim 5 comprising a sufficient structural rigidity to support said plurality of engine exhaust manifolds and a plurality of connectors operatively associated with said plurality of engine exhaust manifolds, wherein during operation of said apparatus, said apparatus supports said plurality of engine exhaust manifolds and said plurality of connectors in a linear orientation.

7. The apparatus according to claim 1 wherein said at least one first lift attachment device comprises a first back side eye bolt which at least partially supports said back side of said apparatus and a first front side eye bolt which at least partially supports said front side of said apparatus, and said at least one second lift attachment device comprises a second back side eye bolt which at least partially supports said back side of said apparatus and a second front side eye bolt which at least partially supports said front side of said apparatus.

8. An engine maintenance apparatus for the removal or replacement of engine exhaust manifolds comprising:
an engine engagement side, wherein said engine engagement side includes a plurality of cutouts and a plurality of separators, wherein each of said plurality of cutouts is adjacent to at least one of said plurality of separators, wherein said cutouts and said separators are dimensioned such that an engine exhaust manifold neck fits in each of said cutouts adjacent to at least one of said plurality of separators during operation of said apparatus;
a cradle connected to said engine engagement side, wherein during operation of said apparatus a plurality of engine exhaust manifold bodies are supported in said cradle;
a back side connected to said cradle opposite from said engine engagement side;
a first end having at least one first lift attachment device;
a second end having at least one second lift attachment device, wherein during operation of said apparatus said first lift attachment device and said second lift attachment device are adjustable to orient said apparatus with a plurality of said engine exhaust manifolds; and
wherein said apparatus is sufficiently rigid to support said plurality of said engine exhaust manifolds.

9. The apparatus according to claim 8 comprising at least one support which provides additional structural support along the length of said apparatus.

10. The apparatus according to claim 9 wherein said at least one support comprises an engine engagement side support which supports a transition between said engine engagement side and said cradle of said apparatus, wherein said engine engagement side support is dimensioned such that during operation of said apparatus said engine engagement side and said engine engagement side support may pass between parts of said engine.

11. The apparatus according to claim 8 wherein said plurality of said cutouts comprise ten said cutouts.

12. The apparatus according to claim 9 wherein said plurality of said separators are dimensioned to fit between said engine exhaust manifold necks during operation, whereby said separators limit lateral movement of said plurality of engine exhaust manifolds during operation of said apparatus.

13. The apparatus according to claim 8 wherein said engine engagement side is designed with said plurality of said cutouts and said plurality of separators arranged as shown in FIG. 2A.

14. The apparatus according to claim 8 wherein said engine engagement side is designed with said plurality of said cutouts and said plurality of separators arranged as shown in FIG. 3A.

15. A method of removing a plurality of engine exhaust manifolds on an engine maintenance apparatus, wherein said engine maintenance apparatus comprises an engagement side with a plurality of cutouts which support necks of said engine exhaust manifolds, a plurality of separators which fit between said necks of said engine exhaust manifolds, and a cradle which supports bodies of said plurality of said engine exhaust manifolds, comprising the steps of:
positioning said engine maintenance apparatus such that said engagement side is adjacent to said engine and underneath said necks of said engine exhaust manifolds, and said cradle is underneath said bodies of said plurality of said engine exhaust manifolds;
engaging said engine maintenance apparatus with said plurality of engine exhaust manifolds wherein said engagement comprises raising said engine maintenance apparatus such that at least one of said plurality of cutouts are in contact with said necks and all of said plurality of cutouts are within a tolerance of said necks, and said cradle is in contact with at least one of said bodies and is within a tolerance of all said bodies;
disconnecting said engine exhaust manifolds from said engine; and
moving said plurality of engine exhaust manifolds supported on said engine maintenance apparatus away from said engine.

16. The method according to claim 15 further comprising the steps of removing a heat shield from covering said plurality of engine exhaust manifolds and removing insulation from said plurality of engine exhaust manifolds.

17. The method according to claim 15 wherein said plurality of said separators are dimensioned to fit between said necks, whereby said separators limit lateral movement of said plurality of engine exhaust manifolds.

18. The method according to claim 15 further comprising the step of lifting said plurality of engine exhaust manifolds to remove pressure from a connection between said engine exhaust manifolds and said engine prior to disconnecting said engine exhaust manifolds from said engine.

19. An apparatus for use in removing heavy components from an engine for maintenance including a jig configured to engage the components while they are connected to the engine and to lift the components away from the engine once they are detached from the engine while maintaining the original spacing and orientation of the components.
